(19) United States
(12) Patent Application Publication
(10) Pub. No.: US 2020/0238872 A1
(43) Pub. Date: Jul. 30, 2020

(54) VEHICLE HEADREST WITH REMOVABLE BLUETOOTH SPEAKER

(71) Applicant: WINDSOR MACHINE AND STAMPING (2009) LTD., Windsor (CA)

(72) Inventor: William Switalski, Windsor (CA)

(21) Appl. No.: 16/777,456

(22) Filed: Jan. 30, 2020

Related U.S. Application Data
(60) Provisional application No. 62/798,780, filed on Jan. 30, 2019.

(51) Int. Cl. B60N 2/879; H04R 1/02; H04R 3/00

(52) U.S. Cl. CPC B60N 2/879; H04R 1/025; H04R 2420/07; H04R 2499/13; H04R 2201/028; H04R 3/00

(57) ABSTRACT

A vehicle headrest assembly includes a housing operatively coupleable to a vehicle seat back. The assembly also includes a cover at least partially surrounding the housing. The assembly further includes a dock operatively coupled to the housing. The assembly yet further includes at least one Bluetooth speaker repeatedly removable and connectable with the dock. The Bluetooth speaker comprises a power source, a wireless receiver, an amplifier, and a loudspeaker, with the wireless receiver coupled to the loudspeaker via the amplifier for reproducing sounds in accordance with a digital signal received by the wireless receiver.

### CROSS-REFERENCE TO RELATED APPLICATION

This application claims priority to U.S. Provisional Application No. 62/798,780, filed on Jan. 30, 2019, which is incorporated herein by reference in its entirety.

### BACKGROUND OF THE INVENTION

The subject matter disclosed herein relates to headrests and, more particularly, to a headrest with Bluetooth speakers incorporated therewith.

Many vehicles, such as automobiles, include a headrest atop an occupant's seat and in a position adjacent the occupant's head. Headrests are typically cushioned for comfort and most are commonly finished in the same material as the rest of the seat. Some head restraints are adjustable in one or more manners. Historically, headrests are employed only for safety and comfort, but have not offered electronic technological conveniences for occupants.

### BRIEF DESCRIPTION OF THE INVENTION

According to one aspect of the disclosure, a vehicle headrest assembly comprises a housing operatively coupleable to a vehicle seat back; and a Bluetooth speaker configured to be selectively and repeatedly attached and removed from the housing. The Bluetooth speaker comprises a power source, a wireless receiver, an amplifier, and a loudspeaker, with the wireless receiver coupled to the loudspeaker via the amplifier for reproducing sounds in accordance with a digital signal received by the wireless receiver.

According to another aspect of the disclosure, a vehicle headrest assembly comprises a housing operatively coupleable to a vehicle seat back, a cover at least partially surrounding the housing, a dock attached to the housing, and at least one Bluetooth speaker configured to be selectively coupled and de-coupled from the dock for providing detachable electrical communication therebetween.

According to another aspect of the disclosure, a vehicle headrest assembly comprises a housing operatively coupleable to a vehicle seat back, at least one Bluetooth speaker including a first coupling part, and a second coupling part attached to the housing. The second coupling part is configured to be selectively coupled and de-coupled from the first coupling part for selectively securing the at least one Bluetooth speaker to the housing.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying figure in which:

FIG. 1 is a perspective view of a headrest assembly having Bluetooth speakers therein; and

FIG. 2 is a perspective view of one of the Bluetooth speakers removed from the headrest assembly.

The detailed description explains embodiments of the invention, together with advantages and features, by way of example with reference to the figures.

### DETAILED DESCRIPTION OF THE INVENTION

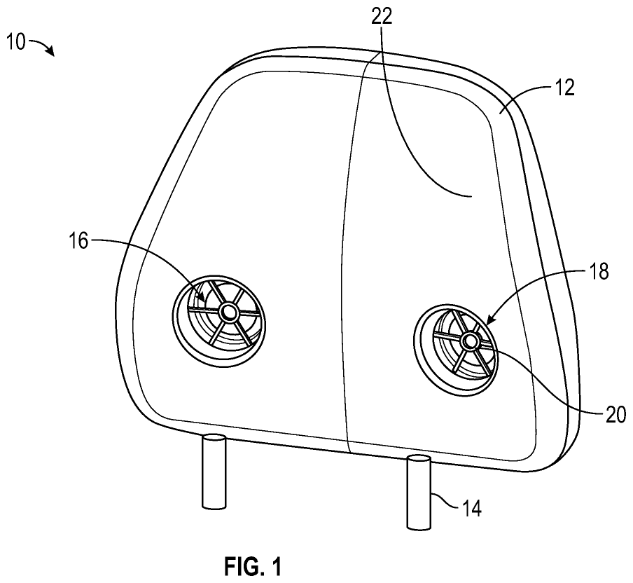

Referring to FIG. 1, a headrest assembly is depicted. The headrest assembly is generally referred to with numeral 10. The headrest assembly 10 includes a housing (not shown) that at least partially encloses several components associated with stabilization and/or adjustment of the headrest assembly. A cushion and a cover 12 are provided over the housing for aesthetic purposes and occupant comfort. A base portion 14 (which may also be referred to as an “armature”) is mountable to a vehicle seat (not shown) and, more specifically, to the upper portion of the seatback of the vehicle seat.

The embodiments of the headrest assembly 10 disclosed herein include at least one speaker 16, 16a, which may be a removable Bluetooth speaker 16a that is configured to be selectively and repeatedly attached and removed from the headrest assembly 10. While a single Bluetooth speaker 16, 16a is contemplated, a plurality of two or more Bluetooth speakers 16, 16a may be employed, as shown. Furthermore, the two or more Bluetooth speakers 16, 16a may include one or more non-removable speakers 16 and/or one or more of the removable Bluetooth speakers 16a. As such, although two Bluetooth speakers 16, 16a are illustrated, it is to be understood that more or fewer speakers 16, 16a may be included in various embodiments. The Bluetooth speaker(s) 16, 16a may be visible from the exterior of the cover 12 in some embodiments, as is the case with the illustrated embodiment.

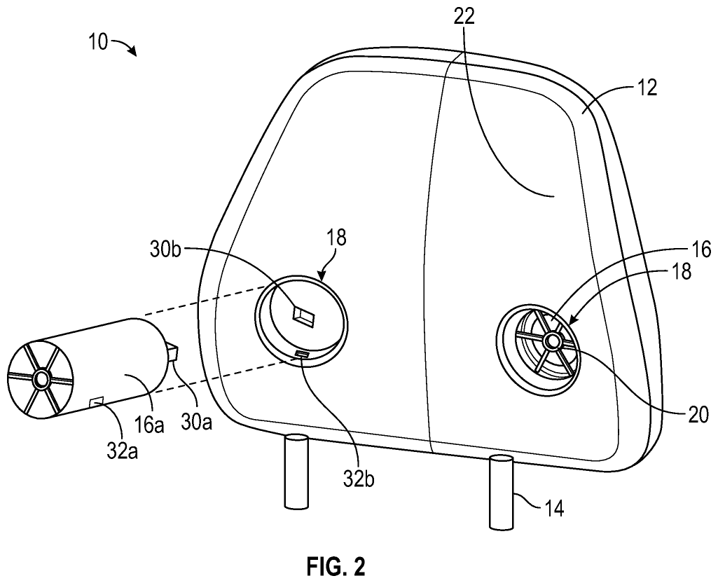

In such embodiments, the housing of the headrest assembly 10 may define an aperture 18 configured to receive at least a portion of the removable Bluetooth speaker 16a. For example, a portion of each of the Bluetooth speaker(s) 16, 16a may be disposed within a respective aperture 18. The most forward point or surface 20 of the Bluetooth speaker 16,16a may protrude out of the cover aperture 18 to protrude from the forward surface 22 of the cover 12, may be flush with the forward surface 22 of the cover 12, or may be recessed within the cover aperture 18 to be recessed from the forward surface 22 of the cover 12. In some embodiments, and as shown in FIG. 2, the aperture 18 may define a round shape and the removable Bluetooth speaker 16a has a generally cylindrical shape configured to fit within the aperture 18.

One or more of the Bluetooth speaker(s) 16, 16a may receive audio signals using any suitable wireless communications protocol, such as Bluetooth. One or more of the Bluetooth speaker(s) 16, 16a may use other wireless communications protocols or standards, such as Wi-Fi, ZigBee, cellular data, or any other open or proprietary wireless communications protocol.

Each of the removable Bluetooth speakers 16a may comprise a power source, such as a battery or a capacitor, a wireless receiver, an amplifier, and a loudspeaker. The power source may be a rechargeable battery or a non-rechargeable battery. The battery may be removable from the removable Bluetooth speakers 16a for replacement. In some embodiments, the battery may be fixed within the removable Bluetooth speakers 16a and not readily replaceable by an end user. The wireless receiver may include hardware and/or software to receive a wireless signal and to decode a digital signal contained therein to extract an audio signal therefrom. The wireless receiver may be coupled to the loudspeaker via the amplifier for reproducing sounds in accordance with the audio signal contained within the digital signal received by the wireless receiver.

The wireless capability of Bluetooth technology to exchange data over short distances to and from mobile devices facilitates convenient use for passengers while seated in a seat with the headrest assembly 10 disclosed herein. As individuals have become increasingly reliant on mobile devices or wearable technology for audio content (e.g., music, podcasts, audio books, etc.), connectivity from relied upon mobile devices or wearable technology to the headrest assembly 10 would add to a passenger experience, particularly in ride sharing vehicles.

Ride sharing is an increasingly popular carpooling option that includes one or more individuals sharing a vehicle to be transported. The headrest assembly 10 disclosed herein alleviates the need for ride sharing passengers to attempt to try to find an agreeable audio option to be played on the vehicle's main audio system, as each passenger with a mobile device or wearable technology (or other electronic devices such as tablets, laptops, etc.) has the capability to quickly and easily connect to the Bluetooth speaker(s) 16 for individual selection of audio content.

Advantageously, the headrest assembly 10 equipped with Bluetooth speaker(s) 16, 16a provides personalized and individual audio control.

As illustrated in FIG. 2, at least one of the Bluetooth speakers 16, 16a is removable from the headrest assembly 10, with the removable speaker referred to with numeral 16a. It is to be understood that the removable Bluetooth speaker 16a is not simply able to be removed and somehow reassembled into the headrest assembly. Rather, the removable Bluetooth speaker 16a is repeatedly removable in a manner that allows the removable Bluetooth speaker 16a to be easily coupled and decoupled from the headrest assembly 10.

Removable Bluetooth speaker(s) 16a may provide for a user to use the same Bluetooth speakers in different locations away from the seat of the vehicle. A user may detach their removable Bluetooth speaker(s) 16a from the headrest assembly 10 and continue to listen to an audio program from anywhere. For example, a user may take the removable Bluetooth speaker(s) 16a to a tailgate or liftgate area of the vehicle or to a campsite and listen to audio sent from an audio head unit in the vehicle. Additionally or alternatively, the user may move the removable Bluetooth speaker(s) 16a away from the vehicle by a large distance and use the removable Bluetooth speaker(s) 16a to listen to audio from another source, such as a smartphone or a computer.

The repeated removability and connection of the removable Bluetooth speaker 16a with the headrest assembly 10 is facilitated with a dock connector 30a attached to the removable Bluetooth speaker 16a, and a corresponding dock 30b attached to the housing. The dock 30b is configured to selectively engage the dock connector 30a for providing electrical communication therebetween. In some embodiments, the dock 30b may be configured to provide a charging power to the Bluetooth speaker 16a for recharging the power source. Alternatively or additionally, in some embodiments, the dock 30b may be configured to provide an audio signal to be reproduced by the loudspeaker of the Bluetooth speaker 16a when the Bluetooth speaker 16a is attached to the vehicle headrest assembly 10. Alternatively or additionally, in some embodiments, the dock 30b may be configured to provide a synchronization signal for pairing the wireless receiver with a wireless transmitter, such as a smartphone, an audio head unit, and/or an infotainment system in the vehicle. Thus, the removable Bluetooth speaker 16a can reproduce sounds in accordance with a specific digital signal transmitted by the wireless transmitter.

The dock connector 30a and the associated dock 30b may include any suitable electrical connector, such as those commonly utilized with Bluetooth speakers, including those commercially available for use with such speakers. For example, a USB connector may be utilized, but this example is not intended to be limiting.

The dock 30b may be connected to a vehicle entertainment system that includes audio content. Connection of the dock is made in a wired or wireless manner. The dock 30b and the associated dock connector 30a allow the removable Bluetooth speaker 16a to be connected to the vehicle entertainment/audio system upon connection of the Bluetooth speaker 16a to the dock 30b.

In some embodiments, and as shown in FIG. 2, a first coupling part 32a is fixed to the removable Bluetooth speaker 16a, and a second coupling part 32b is fixed to the housing, with the second coupling part 32b configured to selectively engage the first coupling part 32a for selectively securing the removable Bluetooth speaker 16a with the housing. Thus, the removable Bluetooth speaker 16a can be securely fixed to the vehicle headrest assembly 10, which may prevent the Bluetooth speaker 16a from becoming detached therefrom until and unless a user intentionally acts to remove it therefrom. The coupling parts 32a, 32b may use any mechanical connection or coupling. In some embodiments, the coupling parts 32a, 32b may be combined with the dock connector 30a and the dock 30b.

In some embodiments, at least one of the first coupling part 32a or the second coupling part 32b comprises a detent to selectively secure the removable Bluetooth speaker 16a with the housing. Such a detent may include a ball and spring in one of the coupling parts 32a, 32b that engages a corresponding pit in the other one of the coupling parts 32a, 32b to hold the removable Bluetooth speaker 16a with the housing until a sufficient force is applied to overcome the detent. In some embodiments, at least one of the first coupling part 32a or the second coupling part 32b may comprise a latch to selectively secure the removable Bluetooth speaker 16a with the housing. In some embodiments, at least one of the first coupling part 32a or the second coupling part 32b may comprise a magnet to selectively secure the removable Bluetooth speaker 16a with the housing. In some embodiments, the first coupling part 32a and the second coupling part 32b may together define a bayonet fitting to selectively secure the removable Bluetooth speaker 16a with the housing. Such a bayonet fitting may be actuated by rotating the removable Bluetooth speaker 16a relative to housing in order to attach or to detach the removable Bluetooth speaker 16a from the housing.

In some embodiments, the first coupling part 32a and the second coupling part 32b may together selectively secure the removable Bluetooth speaker 16a within an aperture 18 of the vehicle headrest assembly 10. Alternatively or additionally, the removable Bluetooth speaker 16a may be fixed on an outer surface, such as a side surface, of the vehicle headrest assembly 10.

In some embodiments, the removable Bluetooth speaker 16a may comprise two or more modules, with each of the modules configured to be separately and independently attached and removed from the housing. For example, the Bluetooth speaker 16a may include two or more modules having a wired or a wireless connection between one another to provide stereo or surround sound when spaced apart from one another. Thus, only one of the modules of the removable Bluetooth speaker 16a may require a power source and/or digital wireless communications capability.

In some embodiments, the only portion of the headrest assembly 10 that is removable from a seat back is the removable Bluetooth speaker 16a. In other words, only the speaker portion of the headrest assembly 10 is removable and not the entire headrest assembly 10, or some other significant portion of the headrest assembly 10. The dock 30 that connects the removable Bluetooth speaker 16a to the vehicle entertainment/audio system and charges the speaker 16a is located in the headrest assembly 10.

In some embodiments, the headrest assembly 10 includes one or more moveable wings. The movable wings may take the form of a bolster or cushion for cushioning a user's head. The removable Bluetooth speaker 16a may be part of—or an entirety of—one of the moveable wing(s). However, it is to be appreciated that the removable Bluetooth speaker 16a may be located in any suitable location of the headrest assembly 10 and in any suitable orientation. For example, the illustrated embodiments show the removable Bluetooth speaker 16a within an aperture 18 of the headrest assembly 10, as described above.

While a headrest assembly 10 has been illustrated and described above, it is contemplated that other vehicle locations may provide a desirable location for removable Bluetooth speaker mounting. For example, an armrest in a second or third row of the vehicle may provide a suitable connecting location.

The repeatedly removable and connectable Bluetooth speaker 16a described herein allows a user to always have a portable Bluetooth speaker available between trips in the vehicle, while realizing the benefits of having a Bluetooth speaker in the vehicle during travel in the vehicle.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A vehicle headrest assembly comprising:
a housing operatively coupleable to a vehicle seat back; and
a Bluetooth speaker configured to be selectively and repeatedly attached and removed from the housing,
the Bluetooth speaker comprising a power source, a wireless receiver, an amplifier, and a loudspeaker, with the wireless receiver coupled to the loudspeaker via the amplifier for reproducing sounds in accordance with a digital signal received by the wireless receiver.

2. The vehicle headrest assembly of claim 1, wherein the housing defines an aperture configured to receive at least a portion of the Bluetooth speaker.

3. The vehicle headrest assembly of claim 2, wherein the aperture defines a round shape and the Bluetooth speaker has a generally cylindrical shape configured to fit within the aperture.

4. The vehicle headrest assembly of claim 1, further comprising:
a dock connector attached to the Bluetooth speaker; and
a dock attached to the housing and configured to selectively engage the dock connector for providing electrical communication therebetween.

5. The vehicle headrest assembly of claim 4, wherein the dock is configured to provide a charging power to the Bluetooth speaker for recharging the power source.

6. The vehicle headrest assembly of claim 4, wherein the dock is configured to provide an audio signal to be reproduced by the loudspeaker of the Bluetooth speaker with the Bluetooth speaker attached to the vehicle headrest assembly.

7. The vehicle headrest assembly of claim 4, wherein the dock is configured to provide a synchronization signal for pairing the wireless receiver with a wireless transmitter, thereby allowing the Bluetooth speaker to reproduce sounds in accordance with a specific digital signal transmitted by the wireless transmitter.

8. The vehicle headrest assembly of claim 1, further comprising:
a first coupling part fixed to the Bluetooth speaker; and
a second coupling part fixed to the housing, with the second coupling part configured to selectively engage the first coupling part for selectively securing the Bluetooth speaker to the housing.

9. The vehicle headrest assembly of claim 8, wherein at least one of the first coupling part and the second coupling part comprises a detent to selectively secure the Bluetooth speaker to the housing.

10. The vehicle headrest assembly of claim 8, wherein at least one of the first coupling part and the second coupling part comprises a latch configured to selectively secure the Bluetooth speaker to the housing.

11. The vehicle headrest assembly of claim 8, wherein at least one of the first coupling part and the second coupling part comprises a magnet configured to selectively secure the Bluetooth speaker to the housing.

12. The vehicle headrest assembly of claim 8, wherein a portion of the at least one Bluetooth speaker is located within an aperture of the cover, and wherein the second coupling part is configured to selectively secure the Bluetooth speaker to the aperture.

13. The vehicle headrest assembly of claim 1, further comprising:
a cover defining a forward surface; and
wherein the Bluetooth speaker is configured to be flush with the forward surface of the cover when the Bluetooth speaker is attached to the housing.

14. The vehicle headrest assembly of claim 1, further comprising:
a cover defining a forward surface; and
wherein the Bluetooth speaker is configured to be recessed from the forward surface of the cover when the Bluetooth speaker is attached to the housing.

15. The vehicle headrest assembly of claim 1, wherein the Bluetooth speaker comprises two or more modules, with each of the modules configured to be separately and independently attached and removed from the housing.

16. A vehicle headrest assembly comprising:
a housing operatively coupleable to a vehicle seat back;
a cover at least partially surrounding the housing;
a dock attached to the housing; and
at least one Bluetooth speaker configured to be selectively coupled and de-coupled from the dock for providing detachable electrical communication therebetween.

17. The vehicle headrest assembly of claim 15, wherein the at least one Bluetooth speaker comprises two or more Bluethooth speakers.

18. The vehicle headrest assembly of claim 15, wherein a portion of the at least one Bluetooth speaker is located within an aperture of the cover.

19. A vehicle headrest assembly comprising:
a housing operatively coupleable to a vehicle seat back;
at least one Bluetooth speaker including a first coupling part;
a second coupling part attached to the housing and configured to be selectively coupled and de-coupled from the first coupling part for selectively securing the at least one Bluetooth speaker to the housing.

20. The vehicle headrest assembly of claim 19, wherein the at least one Bluetooth speaker comprises two or more Bluetooth speakers.
